(19) United States
(12) Patent Application Publication
(10) Pub. No.: US 2002/0012063 A1
(43) Pub. Date: Jan. 31, 2002

(54) Apparatus for automatically detecting focus and camera equipped with automatic focus detecting apparatus

(75) Inventor: Kazuya Kobayashi, Hachioji-shi (JP)

Correspondence Address: Straub & Pokotylo, 1 Bethany Road, Building 6, Suite 83, Hazlet, NJ, 07730, US

(73) Assignee: Olympus Optical Co., Ltd.

(21) Appl. No.: 09/803,699

(22) Filed: Mar. 9, 2001

(30) Foreign Application Priority Data
Mar. 10, 2000 (JP) 2000-066972

(51) Int. Cl. H04N 5/232

(52) U.S. Cl. 348/345; 348/370; 348/354

(57) ABSTRACT

In an automatic focus detecting apparatus, an image which is formed on an imaging device by a photographing lens is converted into a video signal containing a high frequency component. The video signal is read out for every field period VD while changing the image forming state on the imaging device, and the video signal is separated into three groups of video signal components sampled at 3 VD period, which is the least common multiple of the flicker period (1/100 second) of the light source and the field period VD (1/60 second). The peak positions of the three groups of the high frequency components are detected, and a curve of a contrast values is determined by an interpolation calculation that is performed on the basis of each peak position so as to detect the in-focus position of the photographing lens.

### CROSS-REFERENCE TO RELATED APPLICATIONS

This application is based upon and claims the benefit of priority from the prior Japanese Patent Application No. 2000-066972, filed Mar. 10, 2000, the entire contents of which are incorporated herein by reference.

### BACKGROUND OF THE INVENTION

The present invention relates to an automatic focus detecting apparatus, particularly, to an automatic focus detecting apparatus that permits automatically detecting a focus based on an imaging signal supplied from an imaging device without being affected by a flicker from an flickering illuminating device such as a fluorescent lamp.

In an image pickup device for photographing an image with an imaging device such as a CCD, known is a so-called “mountain climbing” method, in which the focus of a lens is adjusted on the basis of a video signal supplied from the image pickup device (Report on NHK Technical Research, 1965, Vol. 17, No. 1, Sum Total No. 86, pp 21-37). In this system, a focusing lens is driven so as to change the position of the lens, thereby detecting the video signal relative to each lens position and obtaining the amount of the high frequency component of an object image denoting the in-focus degree relative to the lens position, i.e., a contrast value, as shown in FIG. 1. The focusing lens is driven to a position where the amount of the high frequency component reaches a peak, i.e., the maximum contrast position, so as to permit the lens to be aligned with the in-focus position.

However, the system of this kind gives rise to a problem. Specifically, a photographing apparatus such as a video camera or electronic still camera, in which sampling is performed by an NTSC system (field frequency of 60 Hz), is flickered at 100 Hz in the case of using a fluorescent lamp operated at a commercial frequency of 50 Hz. If an object is photographed with the light ray emitted from the fluorescent lamp, a flicker component of 20 Hz is superposed with the amount of the high frequency component in the video signal. FIG. 2 is a graph showing the amount of the high frequency component superposed with the flicker component. In FIG. 2, a flicker is generated at a period of 3 VD, which is three times as high as the field period. As a result, it is impossible to obtain an accurate maximum contrast value, leading to a problem of a false focusing under the influence of the flicker.

Systems (1) and (2) given below are known to be effective for canceling the influence of the flicker:

(1) If the contrast value is sampled at 3 VD (vertical deflection) period, the flicker can be canceled so as to perform appropriately the operation to bring the photographing lens into focus. To be more specific, a video signal is read at 3 VD period, and the high frequency component of the video signal that is repeatedly read out is detected so as to drive the photographing lens to a position at which the high frequency component exhibits a peak position.

(2) A video signal is read out with the shutter speed set equal to or an integer number times as long as the flicker period of, for example, a fluorescent lamp. Then, the high frequency component of the video signal that is repeatedly read out is detected, and the photographing lens is driven to a position at which the high frequency component exhibits a peak. For example, if the focusing operation of the photographing lens is performed with the shutter speed set at 1/100 second (100 Hz), the focusing operation can be performed without receiving an influence of the flicker.

However, if systems (1) and (2) given above are employed, the following problems are generated. Specifically, in system (1), the contrast value is sampled only every 3 VD periods, with the result that the focusing operation is retarded by about 3 times as much as that for the focusing apparatus in which the contrast value is sampled for every VD period. Also, in system (2), the shutter speed is fixed, resulting in failure to obtain a sufficient contrast value under a special photographing environment, e.g., where the focusing operation is performed under a low luminance. In the worst case, the focusing cannot be performed.

### BRIEF SUMMARY OF THE INVENTION

An object of the present invention is to provide an automatic focus detecting apparatus that permits accurately detecting the focus position of a photographing lens even under a low luminance without being affected by a flicker of an illuminating apparatus such as a fluorescent lamp and without retarding the focusing operation.

According to a preferred embodiment of the present invention, there is provided an automatic focus detecting apparatus, in which a video signal of an optical image formed on an imaging device by a photographing lens is obtained, and the focal point of the photographing lens is detected on the basis of the high frequency component of the video signal, comprising:

means for reading the video signal at a predetermined time interval while changing the image forming state on the imaging device;

means for separating the video signal into a plurality of components read out at a time interval equal to an integer number times as much as the flicker period of a light source and equal to an integer number times as much as the read out period of the video signal and detecting the peak position of the high frequency component contained in each of the separated video signal components; and

means for performing an interpolation calculation based on a plurality of peak positions obtained by the detecting means so as to detect the in-focus position.

It is desirable for the automatic focus detecting apparatus of the present invention to be worked as follows:

(1) The calculating means should be for obtaining an arithmetic average value of a plurality of peak positions.

(2) The calculating means should be for performing a weighted average interpolation calculation for a plurality of peak positions.

(3) In the weight average interpolation calculation, the coefficient for multiplying the peak position should be 2ⁿ (n being an integer).

(4) Where the flicker period is 1/100 second and the read out period is 1/60 second, the detecting means is for dividing the video signal into three components read out at a period of 1/20 second (3 VD), which is the least common multiple of these flicker period and read out period.

(5) Where the video signal is divided by the detecting means into three components read out at 3 VD period, the calculating means should perform the weighted average interpolation calculation with the heaviest weight put in the intermediate position among the three peak positions obtained by the detecting means.

According to the present invention, it is possible to eliminate the influence of the flicker by separating the video signal into a plurality of components read out at a time interval equal to an integer number times as much as the flicker period of the light source and equal to an integer number times as much as the read out period of the video signal. In this case, since the contrast information is taken for every field, not simply at 3 VD periods, an inconvenience such as the retarded focusing operation does not take place. Further, since the shutter speed is not fixed at 1/100 second but is optionally variable within the range of the read out period of the video signal, the focus can be detected accurately even under a low luminance. It should also be noted that the focus can be detected more accurately by performing an interpolation calculation based on the peak positions of a plurality of components.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a graph showing the relationship between the amount of the high frequency component acquired via a photographing lens relating to a focus detecting system called a mountain climbing method, i.e., the contrast value, and the lens position of the photographing lens;

FIG. 2 is a graph showing the relationship between the contrast value acquired via a photographing lens that is affected by a flicker under illumination by an illuminating apparatus such as a fluorescent lamp and the position of the photographing lens;

FIG. 3 is a block diagram showing an automatic focus adjusting apparatus for automatically adjusting the focus of a photographing lens according to a first embodiment of the present invention;

FIG. 4 is a functional block diagram for explaining the function of the focus detecting operation performed by an arithmetic processing circuit;

FIG. 5 is a graph showing the situation that flicker is generated at a period three times as much as the field period (VD period);

FIG. 6 is a graph representing a relation between a contrast value and the position of the photographing lens, under illumination with flickering; and

FIGS. 7A and 7B are flow charts showing the operations executed by the automatic focus adjusting apparatus shown in FIG. 3 for the focus detection.

### DETAILED DESCRIPTION OF THE EMBODIMENT

An automatic focus adjusting apparatus according to a preferred embodiment of the present invention will now be described with reference to the accompanying drawings.

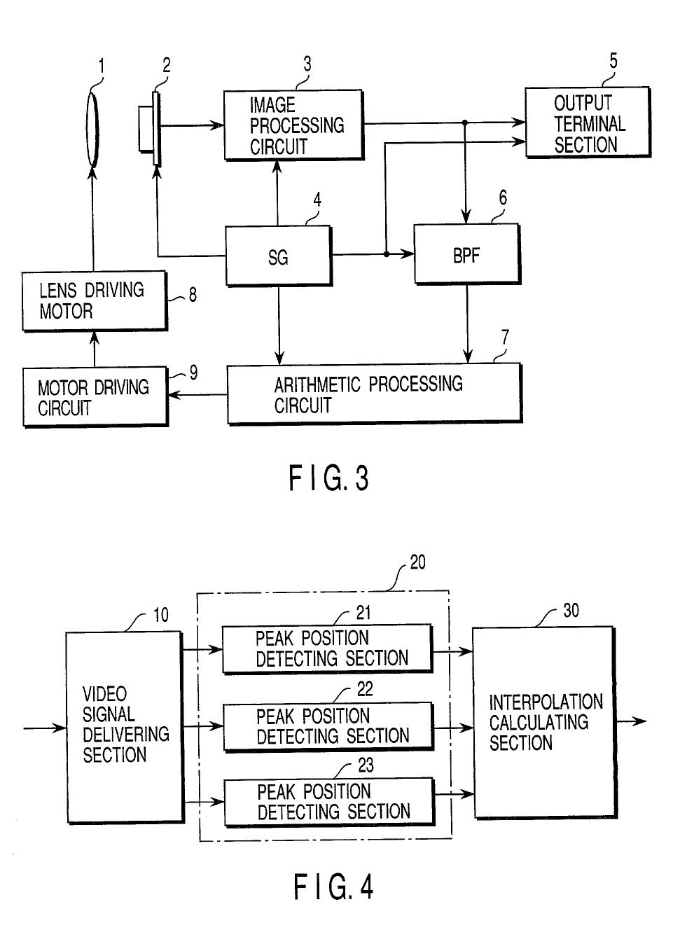

FIG. 3 is a block diagram showing the main constituents of an automatic focus adjusting apparatus of the present invention.

The photographing apparatus shown in FIG. 3, e.g., a digital camera comprises a photographing lens system 1 having movable focusing lens or lenses and a lens driving motor 8 for driving lens or lenses of the photographing lens system 1. The movable focusing lens or lenses of the photographing lens system 1 is driven by the lens driving motor 8 to an in-focus position for photographing an object. The light ray from the object is taken in through the photographing lens system 1 so as to form an image of the object on an imaging device 2, e.g., a CCD. The image of the object is converted into an electric signal by the imaging device 1, and the resultant electric signal is supplied to an image processing circuit 3. In the image processing circuit 3, the image signal is amplified and subjected to a sample and hold processing. Also, the image signal is subjected to an A/D conversion, and a brightness/color conversion treatment is applied to the image signal in the image processing circuit 3, with the result that a digital image signal is generated from the image processing circuit 3. The photographing apparatus shown in FIG. 3 also comprises an SG (signal generating) circuit, i.e., a pulse generating circuit 4, for generating a reference signal, i.e., various pulses such as horizontal and vertical synchronizing signals, required for the video signal processing and an output terminal section 5 for supplying a video signal to a video recording-reproducing system (not shown). The image signal generated from the image processing circuit 3 is supplied to a BPF circuit (band pass filter) 6. In the BPS circuit (band pass filter) 6, the high frequency component for evaluating the in-focus degree is extracted from the brightness signal included in the image signal. The photographing apparatus further comprises an arithmetic processing circuit 7 formed of a CPU, a ROM, a RAM, a timer, etc. and a motor driving circuit 9 for the lens driving motor 8.

In the photographing apparatus of the construction described above, the light ray of the object is taken in first through the photographing lens system 1 so as to form an image of the object on the light receiving surface of the imaging device 2. The output signal, i.e., video signals from the imaging device 2 is subjected to an image signal amplification, a sample and hold processing, an A/D conversion, a brightness/color conversion, etc. within the image processing circuit 3 and, then, supplied to the output terminal section 5 and to the arithmetic processing circuit 7 through the BPF circuit 6. Further, the output signal of the output terminal section 5 is supplied to a circuit of the recording-reproducing system (not shown). It should also be noted that, in the BPF circuit 6, the amount of the high frequency component, i.e., the contrast value, is extracted from a brightness (Y) signal.

In the arithmetic processing circuit 7, the brightness (Y) signal generated from the image processing circuit 3 is integrated so as to carry out a photometric (AE) treatment, and a white balance (WB) treatment is performed by a color (C) signal. Also, in the BPF circuit 5, the contrast value is integrated so as to execute the automatic focusing (AF) treatment. In this case, a plurality of integration areas of the contrast value are set by utilizing a vertical synchronizing signal or a vertical deflection signal (VD), and a horizontal synchronizing signal or a horizontal deflection signal (HD), and it is possible to make the integration area variable. Similarly, it is also possible to set a plurality of AE/WB areas and to make these AE/WB areas variable. The vertical deflection signal (VD) and the horizontal deflection signal (HD) are connected to an interrupt terminal so as to be utilized for the treatments for the automatic focusing (AF), the photometry (AE), the white balance (WB), etc.

The arithmetic processing circuit discriminates the in-focus state and supervises the position of the focusing lens. In addition to the in-focus position detecting treatment, the arithmetic processing circuit also serves to drive the lens driving motor 8 via the motor drive circuit 9 so as to perform the control function for moving the focusing lens of the photographing lens system 1 to a predetermined position and the function of making variable (element shutter) the accumulated integration time of the imaging device 2 owing to the photometry (AE). By exerting each of these functions, the focus detection and the in-focus operation are carried out. The peak position (top), which is the in-focus position, can be estimated by the Lagrange's interpolation, the spline interpolation, the two dimensional approximate interpolation, etc.

The focus detecting operation performed by the arithmetic processing circuit 7 is realized by the circuit function or soft ware shown in FIG. 4. The video signals, i.e., video components Y, which are read out at respective field periods VD (1/60 second), are sampled and delivered, by a video signal delivering section 10, as three components corresponding to three fields which are read out at an interval of 3 VD (1/20 second). To be more specific, the video signal obtained in the imaging device 2 is sampled at 1/20 second, which is a period corresponding to the least common multiple of the flicker period (1/100 second) of the light source and the read out period (1/60 second) of the video signal so as to be delivered as three components. The three video signal components are supplied to the corresponding sections 21, 22 and 23, respectively, of a peak position detection block 20. Detected in each peak position detection section is the peak position of the high frequency component of the object image relative to the lens position.

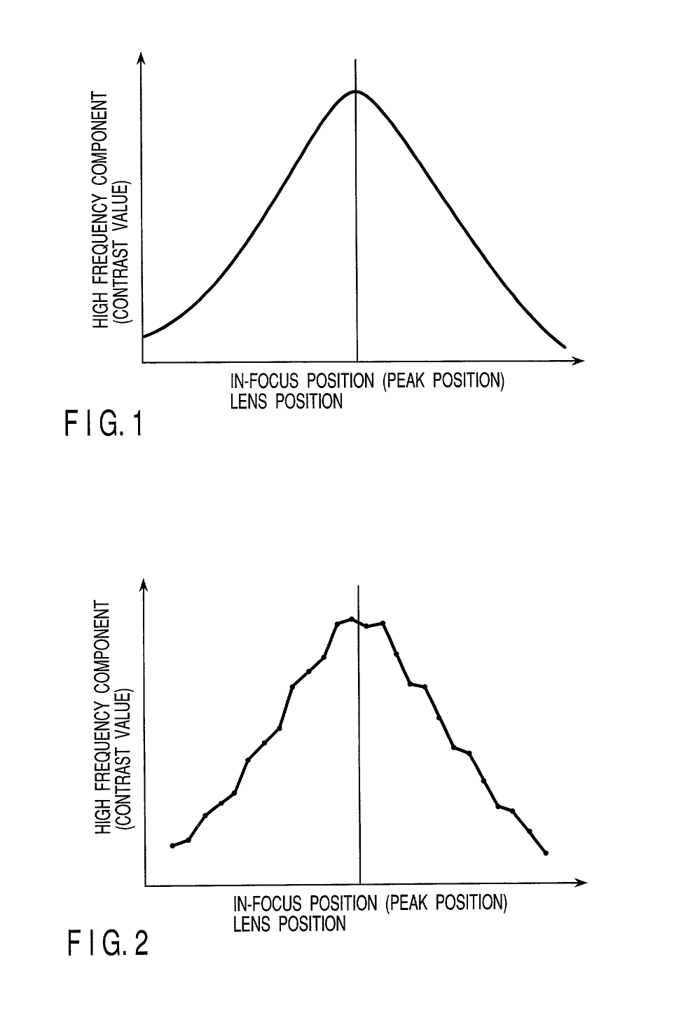

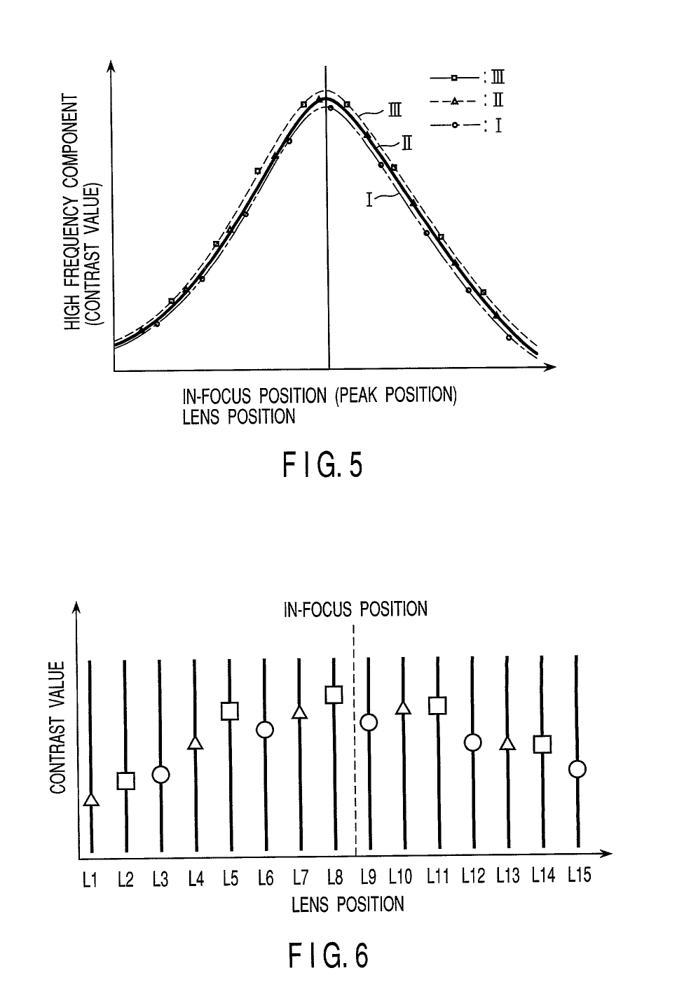

FIG. 5 shows the high frequency components relative to the lens positions, which are obtained in the three peak-position detecting sections 21, 22 and 23. The symbols ◯, Δ and □ shown in FIG. 5 denote the outputs from the detecting sections 21, 22 and 23, respectively. If the symbols ◯ are joined to each other, obtained is a characteristic curve I from which the influence of flicker is removed unlike the curve shown in FIG. 2. Also, if the symbols Δ are joined to each other, obtained is a characteristic curve II from which the influence of flicker is removed unlike the curve shown in FIG. 2. Further, if the symbols □ are joined to each other, obtained is a characteristic curve III from which the influence of flicker is removed unlike the curve shown in FIG. 2.

Then, an interpolation calculation is performed in the interpolation calculation section 30 on the basis of a plurality of peak positions obtained in the three peak-position detecting sections 21, 22 and 23 so as to obtain the in-focus position as follows.

FIG. 6 shows the contrast value at each lens position under the flickering environment. As shown in FIG. 6, the contrast curve is irregular under the influence of the flicker. Under this state, suppose the estimated in-focus positions divided into three groups of 1G (L7, L10, L13), 2G (L5, L8, L11) and 3G (L6, L9, L12) are L8.4, L8.5 and L8.9, respectively. The in-focus positions are obtained by, for example, uniformly putting a weight.

(L8.4+L8.5+L8.9)/3=L8.6 (1)

Alternatively, it is conceivable to obtain the in-focus position by increasing the weight put to the intermediate position of the three estimating points.

(L8.4×1+L8.5×2+L8.9×1)/4=L8.56 (2)

It is also possible to put the weight depending on the positions of the three estimating points. In this case, the heaviest weight is put to the intermediate position of the three estimating points, and the second heaviest weight is put to the position closer to the intermediate position, as follows in this example:

(L8.4×2+L8.5×4+L8.9×1)/7=L8.53 (2)

The weighting is not limited to 2 raised to n-th power. For example, it is possible to rewrite formulas (2) and (3) given above as formulas (2)′ and (3)′ given below:

(L8.4×1+L8.5×3+L8.9×1)/5=L8.56 (2)′

(L8.4×2+L8.5×3+L8.9×1)/6=L8.53 (3)′

As described above, according to this embodiment, the video signal is divided into three components read out at a time interval of 1/20 second, which is three times as much as the field period of 1/60 second, and the contrast value is obtained by an interpolation calculation performed on the basis of the respective peak positions of the high frequency components contained in the divided components of the video signal, thereby detecting the focus of the photographing lens system 1. It should be noted that the period of 1/20 second noted above is the least common multiple of the flicker period (1/100 second) of the fluorescent lamp and the field period of 1/60 second, making it possible to remove the influence of the flicker caused by the fluorescent lamp.

It should also be noted that, since the contrast information is taken for every field, it is possible to avoid an inconvenience such as a retarded focusing operation. Also, since the shutter speed is not fixed but is optionally variable within the range of the read out period of the video signal, it is possible to detect accurately the focus even under a low luminance. Further, it is possible to detect the focus more accurately by performing the interpolation calculation on the basis of the peak positions of a plurality of components.

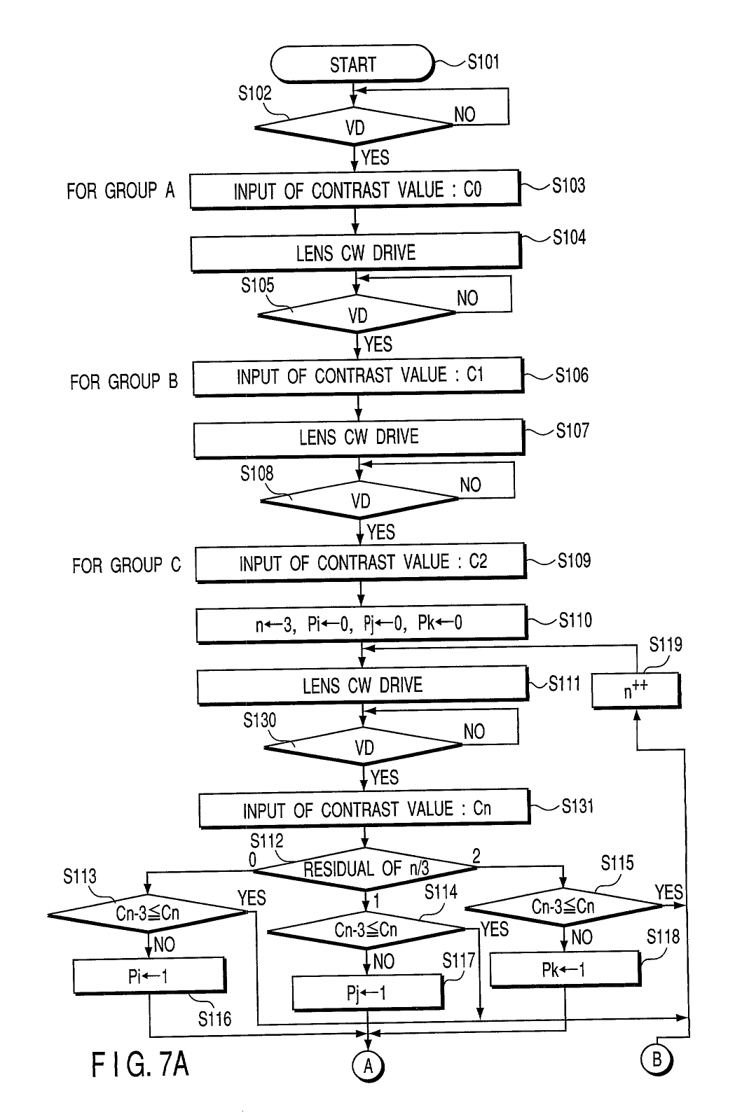

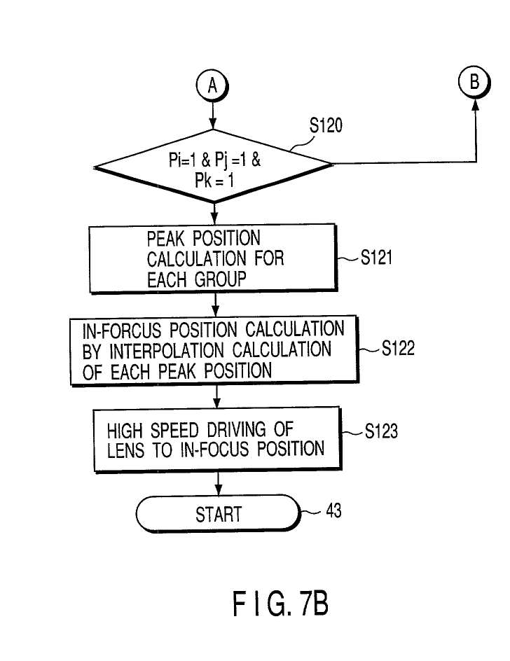

The focus detecting operation performed by the arithmetic processing circuit 7 will now be described in detail with reference to FIGS. 7A and 7B.

If the focus detecting operation is started at step S101, the measurement of the contrast value is started at the position of the photographing lens system 1. In step S101, it is possible for the photographing lens system 1 to be driven so as to be located in a position optically farther than a point at infinity or to be retained as it is at the position where the focusing lens of the photographing lens system 1 is currently located. If the focus detection is started, it is confirmed whether or the vertical deflection signal VD has been supplied to the image processing circuit 3, as shown in step S102. Where the vertical deflection signal VD has not yet been supplied to the image processing circuit 3, the supply of the vertical deflection signal VD is awaited. If the vertical deflection signal VD is supplied to the image processing circuit 3, the video signal component Y is supplied to the BPF 6, the contrast component is generated from the BPF 6 and, then, supplied to the arithmetic processing circuit 7. The contrast component is integrated in the arithmetic processing circuit 7 so as to be stored as contrast value C0 of the first group in the address corresponding to the position of the focusing lens within a memory (not shown) included in the arithmetic processing circuit 7, as shown in step S103. The focusing lens of the photographing lens system 1 is moved forward slightly by the rotation of the lens driving motor 8 in the clockwise direction, as shown in step S104. As shown in step S105, 1/60 second after generation of the vertical deflection signal VD in step S102, the next vertical deflection signal VD is generated. At the same time, the video signal component Y is supplied to the BPF 6, and the contrast component of the video signal component Y is supplied from the BPF 6 to the arithmetic processing circuit 7. The contrast component is integrated in the arithmetic processing circuit 7 so as to be stored as contrast value C1 of the second group in the address, which corresponds to the position of the focusing lens 1, of the memory (not shown) included in the arithmetic processing circuit 7, as shown in step S106. Likewise, the focusing lens of the photographing lens system 1 is slightly moved forward by the rotation of the lens driving motor 8 in the clockwise direction, as shown in step S107. Further, 1/60 second after generation of the vertical deflection signal VD in step S106, the next vertical deflection signal is generated as shown in step S108. If the next vertical deflection signal is generated, the video signal component Y is supplied to the BPF 6 and the contrast component of the video signal component Y is supplied from the BPF 6 to the arithmetic processing circuit 7. The contrast component is integrated in the arithmetic processing circuit 7 so as to be stored as the contrast value C2 of the third group at an address in the memory (not shown) included in the arithmetic processing circuit 7, the address corresponding to the position of the focusing lens, as shown in step S109.

A variable n is set at 3 in step S110, and flags Pi, Pj, Pk are set at “0” so as to drive the focusing lens of the lens system 1 in the point-blank direction (CW direction), as shown in step S111. The generation of the vertical deflection signal VD in step S130 is waited, and the signal is stored as contrast value Cn of any of the first to third groups in the address corresponding to the position the focusing lens of the photographing lens system 1 of the memory (not shown) included in the arithmetic processing circuit 7 in synchronism with the vertical deflection signal VD, as shown in step S131.

Then, it is judged which of the first to third groups the contrast value Cn belongs to in step S112. To be more specific, the variable n of the contrast value Cn is divided by 3 so as to obtain the residual. If the residual is zero, the fourth contrast value C3 belongs to the first group. Therefore, in step S113, the magnitude of the fourth contrast value C3 (n=3) is compared with that of the first contrast value C0 (n−3=0). If the fourth contrast value C3 is larger than the first contrast value C0, the variable n for obtaining the next contrast value C6 belonging to the first group is incremented in step S119 on the ground that the contrast value has not yet reached a peak so as to be brought back to step S111. Also, if the contrast value Cn is the fifth contrast value C4 (n=4), the residual is 1 in step S112 and, thus, the fifth contrast value C4 belongs to the second group. Therefore, the magnitude of the fifth contrast value C4 (n=4) is compared in step S114 with that of the second contrast value C1 (n−3=1). If the fifth contrast value C4 is larger than the second contrast value C1, the variable n for obtaining the contrast value C7 belonging to the second group is incremented in step S119 on the ground that the contrast value has not yet reached a peak so as to be brought back to step S111. Further, if the contrast value Cn is the sixth contrast value C5 (n=5), the residual is 2 in step S112 and, thus, the sixth contrast value C5 belongs to the third group. Therefore, the magnitude of the sixth contrast value C5 (n=5) is compared in step S115 with that of the third contrast value C2 (n−3=2). If the sixth contrast value C4 is larger than the third contrast value C2, the variable n for obtaining the contrast value C8 belonging to the third group is incremented in step S119 on the ground that the contrast value has not yet reached a peak so as to be brought back to step S111.

If the fourth contrast value C3 (n=3) is smaller than the first contrast value C0 (n−3=0) in step S113, the flag Pi is set at “1” in step S116 on the ground that the contrast value has already passed through a peak. Similarly, if the fifth contrast value C4 (n=4) is smaller than the second contrast value C1 (n−3=1) in step S114, the flag Pj is set at “1” on the ground that the contrast value has already passed through a peak. Further, if the sixth contrast value C5 (n=5) is smaller than the third contrast value C2 (n−3=2) in step S115, the flag Pk is set at “1” in step S118 on the ground that the contrast value has already passed through a peak.

Where all the flags Pi, Pj and Pk are “1” in step S120, the operation proceeds to step S121. However, where one of the flags Pi, Pj and Pk is “0”, variable n is incremented in step S119 so as to bring the operation back to step S111, and the operations in steps S111 to S118 are repeated. In step S121, the peak of the contrast value is calculated for each of the first, second and third groups.

The in-focus position of the photographing lens system 1 is calculated from the three peaks obtained from the contrast values of the first, second and third groups, as shown in step S123. The in-focus position is calculated by an interpolation calculation imparted with weight as already described. If the in-focus position is determined, an instruction in respect of the moving direction and the moving amount for moving the photographing lens system 1 to the in-focus position is given from the arithmetic processing circuit 7 to the motor driving circuit 9. In accordance with the moving instruction, the motor driving circuit 9 drives the lens driving motor so as to move the photographing lens system 1 to the in-focus position as shown in step S123. If the photographing lens system 1 is moved to the in-focus position, a series of focusing operations are finished as shown in step S124.

Incidentally, the embodiment described above with reference to FIGS. 6A and 6B covers the case where the number n of samplings is set at 3 (1/60 second×3=1/20 second). However, it is clearly possible to apply without difficulty the technical idea of the present invention to the case where the number n of samplings is set at 6 (1/60 second×6=1/10 second).

The present invention is not limited to the embodiment described above. Specifically, it is possible to apply the technical idea of the present invention not only to an apparatus for photographing a dynamic image such as a video camera or an apparatus for photographing a stationary image such as a digital camera, but also to the apparatus for detecting the focus on the basis of the video signal obtained by an imaging device. It is also possible to modify the present invention in various fashions within the technical scope of the present invention.

As described above in detail, the present invention provides an automatic focus detecting apparatus, which permits removing the influence of flicker of, for example, a fluorescent lamp and also permits accurately detecting the focus even under a low illumination without retarding the focusing operation. In the apparatus of the present invention, a video signal is divided into a plurality of components read out at a time interval equal to an integer number times as much as the flicker period of the light source and equal to an integer number times as much as the read out period of the video signal. The peak position of the high frequency component for each of the divided components of the video signal is detected, and an interpolation calculation is performed by an arithmetic means on the basis of a plurality of peak positions obtained by the detecting means so as to detect the in-focus position, thereby providing an automatic focus detecting apparatus, which permits removing the influence of flicker of, for example, a fluorescent lamp and also permits accurately detecting the focus even under a low illumination without retarding the focusing operation.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An automatic focus detecting apparatus, in which an optical image is formed on an imaging device via a photographing lens, and the focal point of the photographing lens is detected on the basis of the high frequency component contained in a video signal generated from the imaging device even under a light source that is flickered at a flicker period, comprising:
detecting means for sampling the video signal generated at a predetermined time interval at a different timing to deliver a plurality of video signal components, while changing the image forming state on said imaging device, at a time interval equal to an integer number times as much as said flicker period and equal to an integer number times as much as the read out period of the video signal, and detecting the peak position of the high frequency component contained in each group of the video signal components; and
calculating means for performing an interpolation calculation based on a plurality of peak positions obtained by said detecting means so as to detect the in-focus position of the photographing lens.

2. The automatic focus detecting apparatus according to claim 1, wherein said calculating means is for obtaining an arithmetic average value of a plurality of peak positions.

3. The automatic focus detecting apparatus according to claim 1, wherein said calculating means is for performing a weighted average interpolation calculation for a plurality of peak positions.

4. The automatic focus detecting apparatus according to claim 3, wherein, in the weight average interpolation calculation, the coefficient for multiplying the peak position is 2ⁿ (n being an integer).

5. The automatic focus detecting apparatus according to claim 1, wherein the video signal is sampled by said detecting means into three group of the video components read out at a period 3 times as much as the read out period, the calculating means performs the weighted average interpolation calculation with the heaviest weight put in the intermediate position among the three peak positions obtained by the detecting means.

6. An automatic focus detecting apparatus used in an electronic camera that permits photographing an object as an electronic image by bringing the object into focus even under a light source flickered at a certain flicker period, comprising:
a photographing lens system including a focus lens movable for the focus adjustment;
lens driving means for driving the focus lens of the photographing lens system;
an imaging device for forming an optical image of the object transmitted through the photographing lens system and for converting the optical image into a video signal;
detecting means for sampling, while driving a photographing lens, a video signal generated from the imaging device at a time interval equal to an integer number times as much as said flicker period and sampling a high frequency component contained in the video signal at a time interval equal to an integer number times as much as a predetermined period of the video signal so as to divide the video signal into a plurality of groups, and detecting the peak position of the high frequency component contained in each of the signal components for each group;
arithmetic means for performing an interpolation calculation for calculating the in-focus position of the photographing lens on the basis of a plurality of peak positions obtained by said detecting means; and
control means for controlling the lens driving means to move the photographing lens to the calculated in-focus position.

7. The automatic focus detecting apparatus according to claim 6, wherein said arithmetic means serves to obtain an arithmetic average value of said plurality of peak positions.

8. The automatic focus detecting apparatus according to claim 6, wherein said arithmetic means performs an interpolation calculation for obtaining a weighted average of said plurality of peak positions.

9. The automatic focus detecting apparatus according to claim 6, wherein, in the weight average interpolation calculation, the coefficient for multiplying the peak position is 2ⁿ (n being an integer).

10. The automatic focus detecting apparatus according to claim 6, wherein the video signal read out at a period 3 times as much as the read out period is divided by said detecting means into three components, the calculating means performs the weighted average interpolation calculation with the heaviest weight put in the intermediate position among the three peak positions obtained by the detecting means.
